(19) United States
(12) Patent Application Publication
(10) Pub. No.: US 2024/0349938 A1
(43) Pub. Date: Oct. 24, 2024

(54) Cooking Element Coated With A Peelable Non-Stick Fluorinated Polymeric Film

(71) Applicant: SEB S.A., Ecully (FR)

(72) Inventors: Simon Allemand, Ecully Cedex (FR); Martin Rubio, Ecully Cedex (FR)

(73) Assignee: SEB S.A, Ecully (FR)

(21) Appl. No.: 18/688,525

(22) PCT Filed: Sep. 2, 2022
(86) PCT No.: PCT/FR2022/051657

§ 371 Date: Mar. 1, 2024

(30) Foreign Application Priority Data
Sep. 3, 2021 (FR) FR2109237

(51) Int. Cl. A47J 36/02; A47J 27/00; A47J 37/10; B32B 7/06; B32B 15/08; B32B 27/20; B32B 27/28; B32B 37/06; B32B 37/10; B32B 37/18; B32B 38/10; B32B 43/00; H05B 3/28

(52) U.S. Cl. CPC A47J 36/025; A47J 27/002; A47J 27/004; A47J 37/10; B32B 7/06; B32B 15/08; B32B 27/20; B32B 27/283; B32B 37/06; B32B 37/10; B32B 37/182; B32B 38/10; B32B 43/006; H05B 3/28; B32B 2260/046; B32B 2307/7376; B32B 2307/748; B32B 2311/00; B32B 2371/00; B32B 2377/00; B32B 2509/00

(57) ABSTRACT

The invention relates to a coated cooking element for a kitchen item or electrical cooking apparatus, comprising a metal substrate coated on one side with a peelable film, forming a cooking face, the peelable film comprising one or several layers of fluorinated polymer, a mechanical reinforcing layer and a hotmelt polymer layer arranged on the opposite side to the cooking face and having a melting point higher than 250° C. and lower than or equal to that of at least one of the other layers of the peelable film, the peelable film being assembled with the metal substrate, the hotmelt polymer layer being in contact with the face of the metal substrate. The invention also relates to a method for manufacturing such a coated cooking element and to a cooking article or an electrical cooking appliance having said coated cooking element.

### FIELD OF THE INVENTION

The present invention relates to the field of cooking elements coated with a peelable non-stick fluorinated polymeric film.

The present invention also relates to culinary items and electric cooking appliances comprising such a cooking element.

### PRIOR ART

In the industry of culinary items comprising a non-stick cooking surface, the performance of the coating constitutes one of the most important concerns.

In particular, the mechanical durability of thermostable resin-based coatings, in particular those based on polytetrafluoroethylene (PTFE), is essential. This durability is generally evaluated by the appearance of scratches on the metal and wear of the coating which results in a loss of the non-stick properties.

Faced with the mechanical stresses inherent in the use of the item, a loss of the mechanical properties of the coating is observed and a delamination of the coating can also be produced.

It is therefore important to develop coatings having a high durability, but also offering the possibility, once the culinary item is too worn, of disassembling said coating from its substrate, in order to proceed to recycling of the coating and of the metal substrate, or to allow the production of a new coating enabling the service life of the culinary item to be prolonged.

Conventionally, a metal substrate is first shaped in order to form a kitchen utensil, then the inner surface of the kitchen utensil is coated with a fluorinated resin having an excellent heat resistance, such as polytetrafluoroethylene (PTFE) or tetrafluoroethylene-perfluoroalkyl vinyl ether (PFA) by means of a liquid-spraying coating process or a powder coating process. An alternative consists in coating the substrate then shaping the thus-coated substrate.

The liquid-spraying coating process has a certain number of disadvantages, in particular concerning the thickness of the coating.

When the metal substrate has a curved shape, it is difficult to obtain a coating of uniform thickness.

Moreover, the thickness of the coating is limited. Cracks may appear if the coating thickness is too large.

The durability of the non-stick properties and the wear resistance is therefore limited by the thickness of the coating that can be obtained according to this process.

The powder coating process also has disadvantages. The coating obtained has pinhead type defects, which can lead to a reduction in the non-stick character.

In order to overcome the disadvantages mentioned above, the prior art describes metal substrates coated by lamination with fluorinated films.

Application KR20160099388 describes the method of obtaining a metal substrate coated with a fluorinated film (without a primer layer comprising an organic compound or an adhesive). The fluorinated film is a multilayer film obtained by successively depositing, on a support, an aqueous dispersion of the constituents of the layer (fluorinated resin and optionally an inorganic filler) which is dried and sintered. The multilayer film is then removed from its support and positioned on the metal substrate before assembly. The layer of fluorinated film in contact with the metal is composed of FEP, PFA, TFM, MFA (or a mixture) which has good flow properties, thus enabling good adhesion. The metal substrate/fluorinated film assembly is produced by thermal compression, in a static press or even between rolls (roll-to-roll process).

Although the method for obtaining a coated substrate by laminating a fluorinated film provides the possibility of having a thicker, and thus more resistant, non-stick film, the mechanical properties of such a film are however not optimal.

In addition, disassembly by peeling of such a film, once worn, is difficult. The mechanical properties of the film can be altered, the upper layers being able to be damaged. The mechanical cohesion between the various layers is then no longer sufficient to enable the multilayer film to be removed without tearing.

The prior art describes other methods for assembling a fluorinated film on a substrate.

Application CN206950019 describes a non-stick frying pan comprising a non-stick layer deposited on the inner surface of the cooking utensil. The non-stick layer is preferably composed of PTFE and can be fixed by bonding, but also by embedding or by riveting. The film assembled by embedding cannot be easily removed. Although riveting can enable disassembly of the film and the substrate, this option is however unsuitable for culinary articles.

Removable cooking sheets can provide a solution to the problem of recycling non-stick cooking coatings, but their use is not suitable for the large majority of culinary items.

### DISCLOSURE OF THE INVENTION

From an industrial point of view, there remains a need to develop higher-performance coatings for culinary items in terms of durability of the non-stick character and of wear resistance and which can be easily disassembled from the metal substrate of the culinary item in order to be recycled or to enable the production of a new coating enabling the service life of the culinary item to be prolonged.

It has therefore become necessary to develop a metal substrate coated with a non-stick film having reinforced mechanical properties, the metal substrate and the film also being able to be easily disassembled when the coating is worn.

The applicant has thus developed a cooking element comprising a metal substrate coated with a peelable, non-stick fluorinated polymeric film reinforced by means of a reinforcement layer that is mineral, metallic or polymeric in nature. Said film is assembled on said substrate by means of a hotmelt polymer layer enabling, by hot peeling, easy disassembly of the film, most particularly when the coating is worn.

### SUMMARY OF THE INVENTION

A first object of the invention relates to a coated cooking element (1) for a culinary item or electric cooking appliance, comprising a metal substrate (2) coated on one face (2a) with a peelable film (3), forming a cooking face (5), the peelable film (3) comprising one or more layers of fluorinated polymer(s) (7), a mechanical reinforcing layer (6) and a layer of hotmelt polymer(s) (4) arranged on the opposite side to the cooking face (5) and having a melting point higher than 250° C. and lower than or equal to that of at least one of the other layers of the peelable film (3), said peelable film (3) being assembled with the metal substrate (2), the layer of hotmelt polymer(s) (4) being in contact with the face (2a) of the metal substrate (2).

Another object of the invention relates to a coated cooking element (1) for a culinary item or electric cooking apparatus, comprising a metal substrate (2) coated on one face (2a) with a peelable film (3), forming a cooking face (5), the peelable film (3) comprising one or more layers of fluorinated polymer(s) (7), a mechanical reinforcing layer (6) and a layer of hotmelt polymer(s) (4) arranged on the opposite side to the cooking face (5) and having a melting point higher than 250° C. and lower than that of the other layers of the peelable film (3), said peelable film (3) being assembled with the metal substrate (2), said layer of hotmelt polymer(s) (4) being in contact with the face (2a) of the metal substrate (2).

Another object of the invention relates to a method for manufacturing a coated cooking element (1) according to the invention comprising the following steps:
i. Supplying a metal substrate (2),
ii. Optionally, prior treatment of the face (2a) of said metal substrate (2) intended to be coated,
iii. Supplying a peelable film (3) comprising one or more layers of fluorinated polymer(s) (7), a mechanical reinforcement layer (6) and a layer of hotmelt polymer(s) (4),
iv. Positioning the layer of hotmelt polymer(s) (4) of the peelable film (3) on the face (2a) of the metal substrate (2),
v. Performing the assembly of said metal substrate (2) and the layer of hotmelt polymer(s) (4) of the peelable film (3) by hot pressing.

Another object of the invention relates to a culinary item or an electric cooking appliance comprising a coated cooking element (1) according to the invention.

### DEFINITIONS

The term “film” shall be understood within the meaning of the present invention as an assembly composed of one or more superposed layers intended to be assembled with the metal substrate. The term “film” also corresponds to said assembly, once assembled with the metal substrate.

The term “layer” shall be understood within the meaning of the present invention as a continuous layer or a non-continuous layer. A continuous layer (or also called a monolithic layer) is a single whole forming a total flat surface completely covering the surface on which it is placed or will be placed. A non-continuous layer (or non-monolithic layer) can comprise a plurality of portions thus not being a single whole.

The term “peelable” is understood within the meaning of the present invention to be the peelable film (3) previously assembled on the metal substrate (2) and which can be detached from the metal substrate (2) after having been heated to between 250° C. and 350° C. for several minutes.

The term “hotmelt polymer” is understood within the meaning of the present invention to be a polymer losing all mechanical strength at temperatures higher than its melting point.

The term “aluminium alloy” is understood within the meaning of the present invention to be an aluminium alloy of series 1000, 2000, 3000, 4000, 5000, 6000, 7000 and 8000.

The expression “culinary item” shall be understood within the meaning of the present invention as an object intended for cooking. To do this, it is intended to be heated in order to cook or reheat foods carried by the cooking element or contained in the cooking element.

The expression “object intended to be heated in order to cook or reheat foods carried by the cooking element or contained in the cooking element”, shall be understood within the meaning of the present invention as an object which will be heated by an external heating system such as a cooking hob; such an object can be, in particular, a frying pan, saucepan, sauté pan, wok or barbecue grill, and which is able to transmit heat provided by this external heating system to a material or food in contact with said object.

The expression “electric cooking appliance”, shall be understood within the meaning of the present invention as an object intended for cooking. To do this, it is designed to produce heat.

The expression “object designed to produce heat”, shall be understood within the meaning of the present invention as a heating object having its own heating system.

### DESCRIPTION OF THE FIGURES

FIG. 1 shows a sectional view of an exemplary embodiment of a coated cooking element (1) according to the invention, comprising a peelable film (3) and a metal substrate (2).

FIG. 2 shows a sectional view of the metal substrate (2) and the peelable film (3) before metallurgical assembly.

FIG. 3 shows a three-dimensional view of an exemplary embodiment of a coated cooking element (1) according to the invention, comprising a peelable film (3) and a metal substrate (2), the peelable film (3) being extended by a tab (8) that is not associated with the metal substrate.

FIG. 4 illustrates a coated cooking element (1) according to the invention forming a cooking receptacle.

FIG. 5 illustrates a culinary item (100) comprising a coated cooking element (1) according to FIG. 4.

FIG. 6 illustrates an electric cooking appliance (200) comprising a coated cooking element (1) according to FIG. 4.

### DETAILED DESCRIPTION OF THE INVENTION

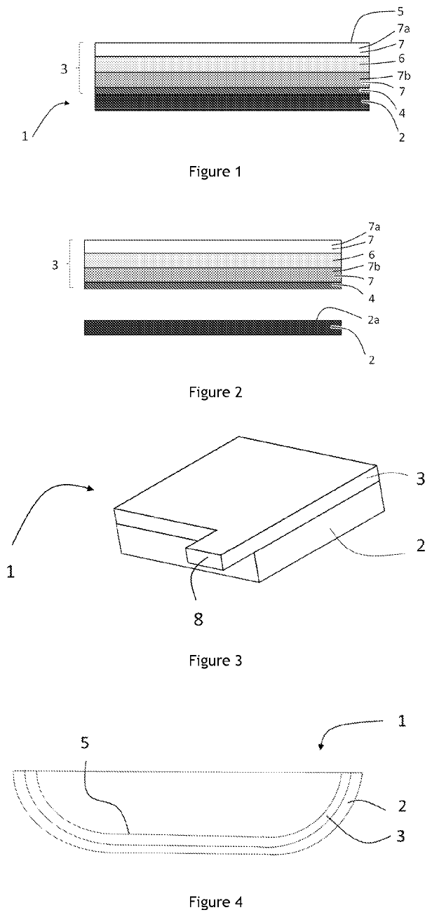

As illustrated in FIGS. 1 to 4, a first object of the invention relates to a coated cooking element (1) for a culinary item or electric cooking appliance, comprising a metal substrate (2) coated on one face (2a) with a peelable film (3), forming a cooking face (5), the peelable film (3) comprising one or more layers of fluorinated polymer(s) (7), a mechanical reinforcing layer (6) and a layer of hotmelt polymer(s) (4) arranged on the opposite side to the cooking face (5) and having a melting point higher than 250° C. and lower than or equal to that of at least one of the other layers of the peelable film (3), said peelable film (3) being assembled with the metal substrate (2), the layer of hotmelt polymer(s) (4) being in contact with the face (2a) of the metal substrate (2).

Advantageously, the layer of hotmelt polymer(s) (4) arranged on the opposite side to the cooking face (5) has a melting point lower than or equal to that of the other layers of the peelable film (3).

Advantageously, the layer of hotmelt polymer(s) (4) arranged on the opposite side to the cooking face (5) has a melting point lower than that of at least one of the other layers of the peelable film (3).

Advantageously, the layer of hotmelt polymer(s) (4) arranged on the opposite side to the cooking face (5) has a melting point lower than that of the other layers of the peelable film (3).

Metal substrates which can be used in the context of the invention can advantageously include substrates made of aluminium, stainless steel, cast iron or aluminium, titanium or copper.

Within the meaning of the present invention, aluminium shall be understood to be a metal composed of 100% aluminium or an aluminium alloy.

According to an embodiment, the metal substrate (2) is a substrate made of aluminium, stainless steel or a multilayer metal substrate. The metal substrate can be a multilayer metal substrate, in particular two-layer or three-layer substrate, composed of different metals such as steel, stainless steel, aluminium, magnesium, copper or titanium, these multiple layers being obtainable, for example, by co-laminating, hot or cold stamping, or by hot diffusion under load (solid state bonding).

The metal substrate (2) preferably comprises alternating layers made of metal and/or metal alloy, or is a cap of cast aluminium, aluminium or aluminium alloys, lined with an outer base of stainless steel.

In general, the peelable film (3) covers the entire face (2a) of the metal substrate (2), but it is also possible that only a part of the metal substrate (2) is covered.

The surface of the metal substrate (2) can be treated prior to the assembly of the peelable film (3) so as to increase its specific surface area and thus improve the adherence of the film; this treatment may be a chemical etching, brushing, sandblasting, shotblasting, physicochemical plasma, corona or laser treatment, chemical activation or a combination of these different techniques.

According to an embodiment, the face (2a) of the metal substrate (2) has undergone a surface treatment prior to the assembly of the peelable film (3) with the face (2a) of the metal substrate (2).

The surface treatment of the face (2a) is chosen from chemical etching, brushing, sandblasting, shotblasting, physicochemical plasma, corona or laser treatment, chemical activation or a combination of these different techniques.

The adhesion of a fluorinated film on a metal substrate presents technical difficulties due to the intrinsic non-stick nature of the fluorinated polymers; one of the solutions involves using a sublayer of hotmelt glue thus enabling the adhesion of the fluorinated film on the metal substrate to be improved.

The peelable film (3) of the coated cooking element (1) according to the invention comprises a layer of hotmelt polymer(s) (4) arranged on the opposite side to the cooking face (5), said layer having a melting point higher than 250° C. and lower than that of the other layers of the peelable film (3).

This enables said layer of hotmelt polymer(s) (4) to maintain good mechanical strength with the substrate at ambient temperature and up to a normal temperature of use of a cooking surface, i.e. approximately 250° C. For temperatures higher than approximately 250° C., the reduction in the mechanical properties of the layer of hotmelt polymer(s) (4) enables disassembly by peeling of the entire peelable film (3).

According to an embodiment, the hotmelt polymer(s) of the layer of hotmelt polymer(s) (4) are chosen from fluoropolymers and silicones.

Preferably, the hotmelt polymer(s) of the layer of hotmelt polymer(s) (4) are chosen from copolymers of tetrafluoroethylene and perfluoropropylvinylether (PFA), copolymers of tetrafluoroethylene and hexafluoropropylene (FEP), copolymers of tetrafluoroethylene and perfluoromethylvinylether (MFA), and the mixtures thereof.

The layer of hotmelt polymer(s) (4) is easily differentiable from the metal substrate (2) by sectional observations with a scanning electron microscope (SEM) or by infrared spectroscopy.

The thickness of the layer of hotmelt polymer(s) (4) of the peelable film (3) of the coated cooking element (1) according to the invention, in other words measured on the cooking element once it has been coated by the peelable film (3), is between 1 μm and 100 μm, preferably between 5 μm and 50 μm.

The measurement of the thickness of the layer of hotmelt polymer(s) (4) is carried out at 20 random points on the section of the peelable film (3). The average thickness of the layer of hotmelt polymer(s) (4) is obtained by taking the average of these 20 measurements.

The peelable film (3) can comprise, among the layers of fluorinated polymer(s) (7), at least one other layer of hotmelt polymer(s), if desired of the same composition as the layer of hotmelt polymer(s) (4), said other layer of hotmelt polymer(s) preferably being arranged between the mechanical reinforcement layer (6) and the cooking face (5), for example between the mechanical reinforcement layer (6) and the one or more layers of fluorinated polymer(s) (7).

In order, on the one hand, to improve the durability of the peelable film (3) and, on the other hand, to enable disassembly of said peelable film (3) by peeling, the peelable film (3) comprises a mechanical reinforcement layer (6).

The mechanical reinforcement layer (6) can improve the durability of the non-stick property and the scratch resistance of the peelable film (3).

In addition, in the absence of a mechanical reinforcement layer (6), the disassembly by peeling of such a film, once worn, is difficult. The mechanical properties of the film can be altered, the upper layers being able to be damaged. The mechanical cohesion between the various layers is then no longer sufficient to enable the multilayer film to be removed without tearing. In the presence of the mechanical reinforcement layer (6), even if the upper layers of the peelable film (3) are damaged, the peelable film (3) can be more easily removed in its entirety by peeling.

The mechanical reinforcement layer (6) comprises a mineral reinforcement, a metallic reinforcement or a non-fluorinated polymer with high thermomechanical properties.

The mechanical reinforcement layer (6) can be a continuous layer or a non-continuous layer.

According to an embodiment, the mineral reinforcement of the mechanical reinforcement layer (6) is chosen from glass fibres, glass-fibre materials or fabrics, carbon fibres and carbon-fibre materials or fabrics.

According to another embodiment, the metallic reinforcement of the mechanical reinforcement layer (6) is a non-continuous metallic element. It may be an expanded metal, perforated metal or even a mesh. In any event, the metallic reinforcement is not a continuous layer.

According to an embodiment, the non-fluorinated polymer with high thermomechanical properties of the mechanical reinforcement layer (6) is chosen from polyaryletherketones (PEAK), such as polyetheretherketone (PEEK) for example, and polyamide-imides (PAI).

The non-fluorinated polymer with high thermomechanical properties of the mechanical reinforcement layer (6) can be in the form of a continuous layer, in the form of a non-continuous layer comprising holes, or in the form of a fibre-type unidirectional reinforcement used in woven or non-woven fabrics.

According to another embodiment, the mechanical reinforcement layer (6) further comprises a polymer impregnating and completely covering said reinforcement.

According to an embodiment, the mechanical reinforcement layer (6) is composed of a mineral reinforcement, a metallic reinforcement or a non-fluorinated polymer with high thermomechanical properties.

According to an embodiment, the peelable film (3) of the coated cooking element (1) according to the invention comprises a single layer of fluorinated polymer(s) (7).

According to another embodiment, the peelable film (3) of the coated cooking element (1) according to the invention comprises a plurality of layers of fluorinated polymer(s) (7), said layers being able to be of different composition.

According to another embodiment, the peelable film (3) of the coated cooking element (1) according to the invention comprises a plurality of layers of fluorinated polymer(s) (7), said layers being of the same composition.

Advantageously, the fluorinated polymer or the mixture of fluorinated polymers of the one or more layers of fluorinated polymer(s) (7) of the peelable film (3) is chosen from the group comprising polytetrafluoroethylene (PTFE), the copolymers of tetrafluoroethylene and polymethylvinylether (MVA), the terpolymers of tetrafluoroethylene, polymethylvinylether and fluoroalkylvinylether (TFE/PMVE/FAVE), and the mixtures thereof.

The thickness of the one or more layers of fluorinated polymer(s) (7) of said peelable film (3) of the coated cooking element (1) according to the invention is between 10 and 400 μm, preferably between 30 and 250 μm, particularly preferably between 50 and 200 μm.

The measurement of the thickness of the one or more layers of fluorinated polymer(s) (7) of the peelable film (3) of the coated cooking element (1) according to the invention, in other words measured on the element once it has been coated by the peelable film (3), is carried out at 20 random points on the section of the film. The average thickness of the metal layer is obtained by taking the average of these 20 measurements.

According to an embodiment, the peelable film (3) of the coated cooking element (1) according to the invention comprises a layer (7a) of fluorinated polymer(s) forming the cooking face (5).

Advantageously, the layer of fluorinated polymer(s) (7a) is (are) chosen from the group comprising polytetrafluoroethylene (PTFE), the copolymers of tetrafluoroethylene and polymethylvinylether (MVA), the terpolymers of tetrafluoroethylene, polymethylvinylether and fluoroalkylvinylether (TFE/PMVE/FAVE), and the mixtures thereof.

Advantageously, the fluorinated polymer or the mixture of fluorinated polymers of the one or more layers of fluorinated polymer(s) (7) of the peelable film (3) is chosen from polytetrafluoroethylene (PTFE) and mixtures comprising polytetrafluoroethylene (PTFE) and one or more fluorinated polymers chosen from the copolymers of tetrafluoroethylene and polymethylvinylether (MVA) and the terpolymers of tetrafluoroethylene, polymethylvinylether and fluoroalkylvinylether (TFE/PMVE/FAVE).

The peelable film (3) of the coated cooking element (1) according to the invention can also comprise at least one filler.

Fillers that can be used in the context of the present invention include, in particular, metal oxides, metal carbides, metal oxynitrides, metal nitrides, silicas and the mixtures thereof.

In the exemplary embodiment illustrated in FIGS. 1 and 2, the peelable film (3) comprises two layers of fluorinated polymer(s) (7a and 7b) and a mechanical reinforcement layer (6).

The total thickness of the peelable film (3) of the coated cooking element (1) according to the invention, in other words measured on the cooking element once it has been coated by the film (3), is between 10 μm and 500 μm, preferably between 30 μm and 300 μm, particularly preferably between 50 μm and 200 μm.

The measurement of the thickness of the peelable film (3) of the coated cooking element (1) according to the invention is carried out at 20 random points on the section of the film. The average thickness of the metal layer is obtained by taking the average of these 20 measurements.

According to an embodiment illustrated in FIG. 3, the peelable film (3) is extended by a tab (8) that is not associated with the metal substrate (2), said tab (8) facilitating the gripping of said peelable film (3) for the operation of disassembly by peeling.

The peelable film (3) can be obtained, before assembly with the metal substrate (2), by depositing a first layer on a support, then optionally by successive depositing of other layers, then by exfoliation of said film in order to separate it from the support. The layers of the peelable film (3) can also be assembled by any other assembly method, such as laminating for example.

The thickness of the layer of hotmelt polymer(s) (4) of the peelable film (3) before assembly with the metal substrate (2) is between 1 μm and 100 μm, preferably between 5 μm and 50 μm.

The thickness of the one or more layers of fluorinated polymer(s) (7) of the peelable film (3) before assembly with the metal substrate (2) is between 10 and 400 μm, preferably between 30 and 250 μm, particularly preferably between 50 and 200 μm.

The total thickness of the peelable film (3) before assembly with the metal substrate (2) is between 10 μm and 500 μm, preferably between 30 μm and 300 μm, particularly preferably between 50 μm and 200 μm.

Another object of the invention relates to a method for manufacturing a coated cooking element (1) according to the invention comprising the following steps:
i. Supplying a metal substrate (2),
ii. Optionally, prior treatment of the face (2a) of said metal substrate (2) intended to be coated,
iii. Supplying a peelable film (3) comprising one or more layers of fluorinated polymer(s) (7), a mechanical reinforcement layer (6) and a layer of hotmelt polymer(s) (4),
iv. Positioning the layer of hotmelt polymer(s) (4) of the peelable film (3) on the face (2a) of the metal substrate (2),
v. Performing the assembly of said metal substrate (2) and the layer of hotmelt polymer(s) (4) of the peelable film (3) by hot pressing.

Step v. of assembly by hot pressing is preferably carried out at a temperature between 250° C. and 350° C.

FIG. 4 illustrates a coated cooking element (1) according to the invention forming a cooking receptacle. The peelable film (3) assembled with the metal substrate (2) forms the cooking face (5) arranged inside the cooking receptacle.

The method for peeling the peelable film (3) from a coated cooking element (1) according to the invention comprises the following steps:
a) Heating the cooking element to a temperature between 250° C. and 350° C.
b) Disassembling by peeling the peelable film (3) and the metal substrate (2), where applicable by means of the tab (8) facilitating the gripping of said peelable film (3).

Step a) of heating can be carried out by means of any heat generating appliance, such as an oven for example. The heating time depends on the size of the cooking element to be heated and is adjusted consequently.

The disassembly of the peelable film (3) from the metal substrate (2) enables recycling of the worn coating and facilitates recycling of the metal substrate. It also offers the possibility of assembling a new coating, thus enabling the service life of the coated cooking element (1) to be prolonged.

The layer of hotmelt polymer(s) (4) and the mechanical reinforcement layer (6) enable the peelable film (3) to be easily disassembled from the metal substrate (2). The mechanical reinforcement layer (6) enables the peelable film (3) to remain cohesive when the layer of hotmelt polymer(s) (4) reaches a temperature exceeding its melting point. Thus a force can be exerted on the peelable film (3) in order to disassemble it from the metal substrate (2). The melting of the layer of hotmelt polymer(s) (4) enables decohesion with the metal substrate (2).

Another object of the invention relates to a culinary item (100) comprising a coated cooking element (1) according to the invention.

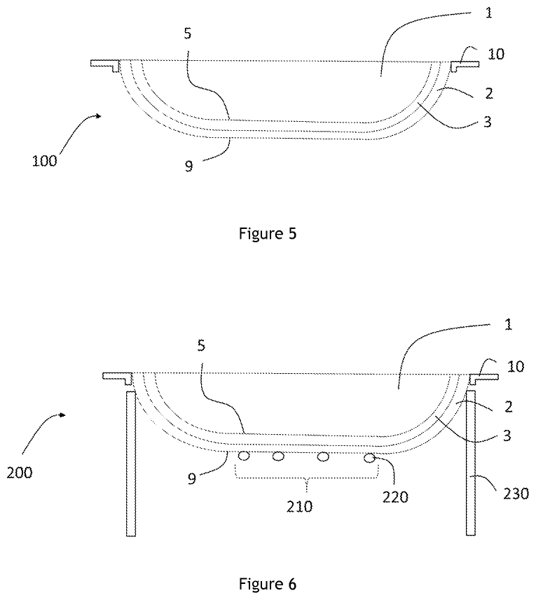

According to an embodiment illustrated in FIG. 5, the culinary item (100) according to the invention comprises a coated cooking element (1) forming a cooking receptacle and is equipped with a gripping member (10) fixed on said coated cooking element (1). The culinary item (100) comprises a heating face (9) intended to be placed in contact with an external heating source, the heating face (9) being opposite the cooking face (5) intended to be placed in contact with foods during cooking.

The culinary item (100) according to the invention is chosen from the group consisting of a saucepan, frying pan, pans or pots for fondue or raclette, stew pot, wok, sauté pan, crêpe maker, grill, plancha grill, cooking pot, casserole, vessel for a cooker or bread-making machine, culinary mould. Thus the culinary item (100) can form a cooking accessory for an electric cooking appliance.

Another object of the invention relates to an electric cooking appliance (200) comprising a coated cooking element (1) according to the invention.

According to another embodiment illustrated in FIG. 6, the electric cooking appliance (200) according to the invention comprises a coated cooking element (1) and a heating source (210) designed to heat said coated cooking element (1). The coated cooking element (1) forming a cooking receptacle is arranged in a heating base (230) comprising the heating source (210) composed of a plurality of heating elements (220). The heating face (9) rests on the heating elements (220). If desired, the heating face (9) can be rigidly attached to the heating elements (220).

The electric cooking appliance (200) according to the invention is chosen from the group consisting of an electric crêpe maker, electric raclette appliance, electric fondue appliance, electric grill, electric plancha grill, electric cooker, bread-making machine.

1. A coated cooking element for a culinary item or electric cooking apparatus, comprising a metal substrate coated on one face with a peelable film, forming a cooking face (5), the peelable film comprising one or more layers of fluorinated polymer, a mechanical reinforcing layer and a layer of hotmelt polymer(s) arranged on the opposite side to the cooking face and having a melting point higher than 250° C. and lower than or equal to that of at least one of the other layers of the peelable film, said peelable film being assembled with the metal substrate, said layer of hotmelt polymer(s) being in contact with the face of the metal substrate.

2-8. (canceled)

9. The coated cooking element according to claim 1, characterised in that the mechanical reinforcement layer comprises a mineral reinforcement, metallic reinforcement or a non-fluorinated polymer with high thermal and mechanical properties.

10. The coated cooking element according to claim 9, characterised in that the mineral reinforcement is chosen from glass fibres, glass-fibre materials or fabrics, carbon fibres and carbon-fibre materials or fabrics.

11. The coated cooking element according to claim 9, characterised in that the metallic reinforcement is a non-continuous metal element.

12. The coated cooking element according to claim 9, characterised in that the non-fluorinated polymer with high thermomechanical properties is chosen from the polyaryletherketones (PEAK) and polyamide-imides (PAI).

13. The coated cooking element according to claim 9, characterised in that the mechanical reinforcement layer further comprises a polymer, impregnating and completely covering said reinforcement.

14. The coated cooking element according to claim 9, characterised in that the mechanical reinforcement layer is composed of a mineral reinforcement, a metallic reinforcement or a non-fluorinated polymer with high thermomechanical properties.

15. The coated cooking element according to claim 1, wherein the hotmelt polymer(s) of the layer of hotmelt polymer(s) are chosen from fluoropolymers and silicones.

16. The coated cooking element according to claim 15, wherein the hotmelt polymer(s) of the layer of hotmelt polymer(s) are chosen from copolymers of tetrafluoroethylene and perfluoropropylvinylether (PFA), copolymers of tetrafluoroethylene and hexafluoropropylene (FEP), copolymers of tetrafluoroethylene and perfluoromethylvinylether (MFA), and the mixtures thereof.

17. The coated cooking element according to claim 1, wherein the thickness of said peelable film is between 10 μm and 500 μm.

18. The coated cooking element according to claim 17, wherein the thickness of the layer of hotmelt polymer(s) of said peelable film is between 1 μm and 100 μm.

19. The coated cooking element according to claim 17, wherein the thickness of the one or more layers of fluorinated polymer(s) of said peelable film is between 10 μm and 400 μm.

20. (canceled)

21. (canceled)

22. The coated cooking element according to claim 1, wherein said peelable film comprises a layer (7a) of fluorinated polymer(s) forming the cooking face.

23. The coated cooking element according to claim 1, wherein the fluorinated polymer or the mixture of fluorinated polymers of the one or more layers of fluorinated polymer(s) of said peelable film is chosen from the group comprising polytetrafluoroethylene (PTFE), the copolymers of tetrafluoroethylene and polymethylvinylether (MVA), the terpolymers of tetrafluoroethylene, polymethylvinylether and fluoroalkylvinylether (TFE/PMVE/FAVE), and the mixtures thereof.

24. The coated cooking element according to claim 1, wherein the peelable film further comprises at least one filler.

25. The coated cooking element according to claim 1, wherein the peelable film is extended by a tab that is not associated with the metal substrate, said tab facilitating the gripping of said peelable film for the operation of disassembly by peeling.

26. A method for manufacturing a coated cooking element according to claim 1 comprising the following steps:
i. Supplying a metal substrate,
ii. Optionally, prior treatment of the face of said metal substrate intended to be coated,
iii. Supplying a peelable film comprising one or more layers of fluorinated polymer(s), a mechanical reinforcement layer and a layer of hotmelt polymer(s),
iv. Positioning the layer of hotmelt polymer(s) of the peelable film on the face of the metal substrate,
v. Performing the assembly of said metal substrate and the layer of hotmelt polymer(s) of the peelable film by hot pressing.

27. A method for peeling the peelable film of a coated cooking element according to claim 1, comprising the following steps:
a) Heating the cooking element to a temperature between 250° C. and 350° C.,
b) Disassembling by peeling the peelable film and the metal substrate, where applicable by means of the tab facilitating the gripping of said peelable film.

28. A culinary item comprising a coated cooking element according to claim 1.

29. (canceled)

30. (canceled)

31. An electric cooking appliance comprising a coated cooking element and a heat source configured to heat said coated cooking element, wherein said coated cooking element is according to claim 1.

32. (canceled)
